(19) United States
(12) Patent Application Publication
(10) Pub. No.: US 2004/0236917 A1
(43) Pub. Date: Nov. 25, 2004

(54) Data illegal use preventing device

(75) Inventors: Kazuo Miyahara, Hyogo (JP); Chikara Yokoyama, Hyogo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/832,243

(22) Filed: Apr. 27, 2004

(30) Foreign Application Priority Data
May 23, 2003 (JP) 2003-146644

(51) Int. Cl. G06F 12/14

(52) U.S. Cl. 711/163

(57) ABSTRACT

A data illegal use preventing device includes an volatile memory for storing an identification value assigned to data read from an information storing and reading unit; a nonvolatile memory for storing the identification value; a power supply for supplying backup electric power to the volatile memory; backup electric power breaking means for breaking a supply of the backup electric power from the power supply to the volatile memory at the time the information storing and reading unit is detached from the device; and actuation permitting means for permitting an actuation of the device when the identification value stored in the volatile memory coincides with that stored in the nonvolatile memory.

### BACKGROUND OF THE INVENTION

1. Field of the Invention

The present invention relates to a data illegal use preventing device for preventing an illegal copy and use of data. More particularly, the invention relates to a data illegal use preventing device for preventing an illegal use of map data used in a vehicle navigation system.

2. Description of the Related Art

In general, a vehicle navigation system displays the current position of a vehicle on a map by making use of map data. Taking account of kaleidoscopic changes of buildings and/or roads, the map data is periodically updated. When a user updates the map data installed in the vehicle navigation system, the user should pay a fixed charge to update the map data.

In this way, when a user legally updates the map data, it is invariably attended by defrayment such as payment of a charge. For this reason, some of users conspire to illegally copy and use the updated map data. Accordingly, it is necessary at any cost to prevent unauthorized duplication and use of the map data.

Such an illegal use often committed not only for the map data, but also for other data involving payment of a fixed charge for an update of the map data. Therefore, protection against an illegal copy and a use of data must extend to such other data.

Meanwhile, there has been proposed an illegal program protecting device disclosed in Japanese Patent Publication JP 62-226335 A (p. 2, FIGS. 1 and 2), in which in order to prevent an illegal copy and a use of a program, when the device is shipped, a value peculiar to the device is previously written in a storage circuit (EPROM), to which the value is writable just only one time. When the device is initially actuated, the value is read from the EPROM, and the program is changed so as not to activate with a value other than the value.

In the illegal copy preventing device, even if a malicious third party intrigues a copy and a use of the program from the circuit in which an unchanged program is being stored, the copied program cannot be available for lack of coincidence with the value, thereby protecting an illegal use of the program.

The illegal use preventing device thus configured as mentioned above proved fruitful in that the program is prohibited from being actuated with a value other than the value to the device. However, in view of circumstances that the device reads the value from the EPROM, and changes the program so as not to activate with a value other than the value, the program is undergone a change. In contrast, when an illegal use of data is to be committed, it is unnecessary to take the trouble to illegally copy the program itself and is able to process data which is illegally copied by the program operable in the device in which the value peculiar to the device is written. In other words, countermeasures taken in the above is merely effective for preventing the program from being used by illegally copying the program, but ineffective for a malicious third party who conspires an illegal copy and a use such data as map data or the like.

### SUMMARY OF THE INVENTION

The present invention has been made to solve the above-mentioned problems. An object of the present invention is to provide a data illegal use preventing device able to easily prevent data from being illegally copied and used.

The data illegal use preventing device according to the present invention includes a volatile memory for storing an identification value assigned to data read from an information storing and reading unit; a nonvolatile memory for storing the identification value; a power supply for supplying backup electric power to the volatile memory; backup electric power breaking means for breaking a supply of the backup electric power from the power supply to the volatile memory at the time the information storing and reading unit is detached from the device; and actuation permitting means for permitting an actuation of the device when the identification value stored in the volatile memory coincides with that stored in the nonvolatile memory.

As mentioned above, according to the present invention, it is arranged to provide the volatile memory and the nonvolatile memory for storing an identification value assigned to data read from an information storing and reading unit which is detachable from the device; the power supply for supplying backup electric power to the volatile memory; the backup electric power breaking means for breaking a supply of the backup electric power from the power supply to the volatile memory when the information storing and reading unit is detached from the device; and the actuation permitting means for permitting an actuation of the device when the identification value stored in the volatile memory coincides with that stored in the nonvolatile memory. Therefore, once the information storing and reading unit is detached from the device, the identification value stored in the volatile memory is lost. Consequently, even if the information storing and reading unit is detached from the device, after that the data stored therein is illegally updated, and in turn the unit is attached to the device, the identification value stored in the volatile memory will in no case coincide with that stored in the nonvolatile memory. As a result, an actuation of the device ends in failure, which easily prevents the data from being used by an illegal copy of the data.

### BRIEF DESCRIPTION OF THE DRAWINGS

FIG. 1 is a block diagram showing a data illegal use preventing device according to a first embodiment of the present invention applied to a navigation system;

FIG. 2 is a perspective view showing a backup power supply provided in a HDD of the data illegal use preventing device shown in FIG. 1;

FIG. 3 is a flow chart explaining an operation of the data illegal use preventing device shown in FIG. 1;

FIG. 4 is a block diagram explaining a state where the HDD is detached from the data illegal use preventing device in FIG. 1; and

FIG. 5 is a flow chart explaining an operation of the data illegal use preventing device in attaching the HDD again after it has detached from the device.

### DETAILED DESCRIPTION OF THE PREFERRED EMBODIMENTS

A preferred embodiment of the present invention will now be described below with reference to the attached drawings.

### First Embodiment

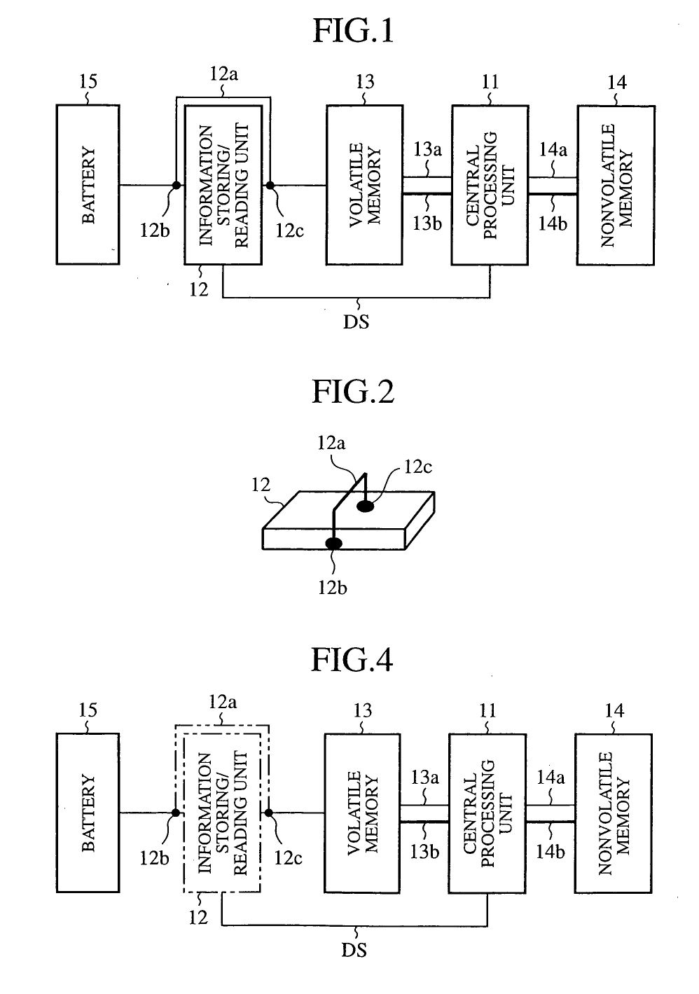

FIG. 1 is a block diagram showing a data illegal use preventing device according to the first embodiment of the present invention applied, e.g., to a navigation system.

Referring to FIG. 1, a central processing unit (CPU) 11 is connected to an information storing and reading unit 12 through a data signal line DS. The information storing and reading unit 12 is, e.g., a hard disk drive (HDD), and to which map data pertaining to a nationwide map or any other data is being stored. The map data is assigned an identifier (ID) such as a code unique to the map data.

The CPU 11 determines the current position of a vehicle (not shown) with the aid of radio waves (GPS) received by a GPS receiver (not shown) from GPS satellites, and plots a position of the vehicle on the map obtained from the map data read to the HDD 12, and displays the position on a display device (not shown) as a display.

As shown in FIG. 1, the CPU 11 is connected to a volatile memory 13 through a first signal line 13a and a second signal line 13b, and to a nonvolatile memory 14 through a third signal line 14a and a fourth signal line 14b. An ID previously assigned to the map data is written in the volatile memory 13 and the nonvolatile memory 14 in a manner as will be described later. The volatile memory 13 is, e.g., a static random access memory (SRAM), and the nonvolatile memory 14 is, e.g., a flash memory (hereinafter referred to simply as a ROM).

As shown in FIG. 2, on the casing (case) of the HDD 12 is formed a wiring 12a, on both ends of which terminals 12b and 12c are provided, respectively. The terminal 12b is connected to a battery 15 (on-board battery, i.e., power supply), and the terminal 12c to the SRAM 13. As a result, electric power is applied to the SRAM 13 from the battery 15 serving as a backup power supply through the wiring 12a.

Turning on a power supply switch (not shown) begins supplying electric power to the CPU 11 and the like. In FIG. 1, the CPU 11, the SRAM 13, the ROM 14, and the wiring 12a for supplying the backup electric power from the battery 15 to the SRAM 13 act as a whole as the data illegal use preventing device, as will be described later.

The operation of the first embodiment will now be described below.

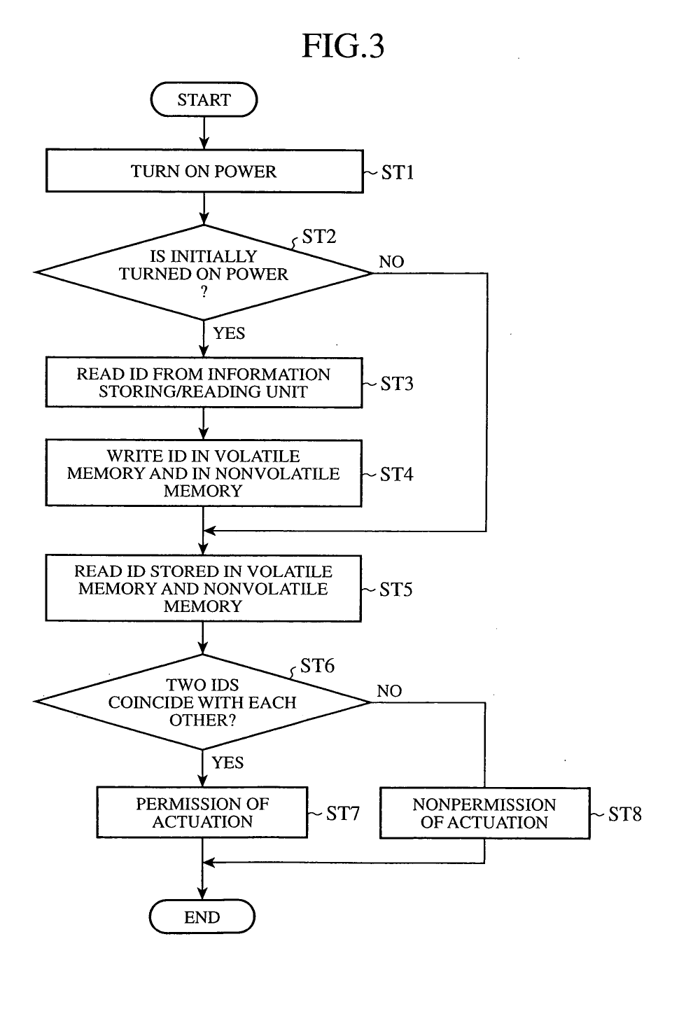

Referring to FIG. 1 and FIG. 3, the power of the vehicle navigation system is turned on (step ST1), the CPU 11 judges whether or not the power is initially turned on (step ST2). If so, the CPU 11 accesses the HDD 12 to read an ID assigned to the map data through the data signal line DS (step ST3). Here, the ID is stored in a given address. The CPU 11 writes the ID in the SRAM 13 through the first signal line 13a (ID writing signal line), and in the ROM 14 through the third signal line 14a (ID writing signal line) (step ST4).

The CPU 11 reads the ID written in the SRAM 13 and the ID in the ROM 14 through the second signal line 13b and the fourth signal line 14b, respectively (step ST5), and compares two IDs to judge whether or not these IDs coincide with each other (step ST6). If coincided with each other, the CPU 11 permits the navigation system to actuate (step ST7). That is, the navigation system begins to actuate, and displays the current position of a vehicle on the map as stated above.

Even though the power to the navigation system is turned off, the ID remains held in the ROM 14, and the ID in the SRAM 13 as they are owing to a supply of the backup electric power to the SRAM 13 from the battery 15.

If it is judged in the step ST2 that the power is not initially turned on, the CPU 11 executes processing from the step ST5 because the ID has already been written in the SRAM 13 and the ROM 14. If these IDs coincide with each other in the step ST6, the CPU 11 permits the navigation system to actuate, or else the CPU 11 does not permit an actuation of the navigation system. That is, the CPU 11 does not begin actuating the navigation system (step ST8).

The map data is periodically updated in conformity with changes in road networks caused by newly constructed roads or buildings. In making an update of the map data stored in the HDD 12, it is recommended to do at an authorized shop managed by a distributor.

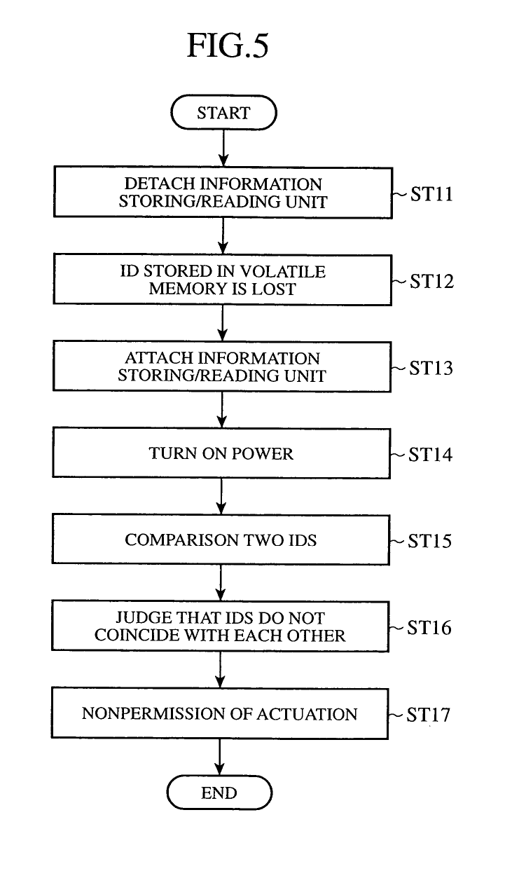

Referring to FIG. 4 and FIG. 5, a discussion will now be held below on the case where a malicious third party commits an illegal copy and an update of the map data. As shown in FIG. 4, first of all, the HDD 12 is detached from the navigation system (step ST11). At this juncture, detaching the HDD 12 compels the terminal 12b and the terminal 12c to disconnect from the battery 15 and the SRAM 13, respectively, resulting in a break of a supply of the backup electric power from the battery 15 to the SRAM 13. As a result, the ID stored in the SRAM 13 is lost (step ST12).

After having copied the updated map data to the HDD 12 (i.e., after having updated the map data stored in the HDD 12), the HDD 12 is attached to the vehicle navigation system (step ST13). At that time, the terminal 12b and the terminal 12c are connected to the battery 15 and the SRAM 13, respectively. After that, when the power to the vehicle navigation system is turned on (step ST14), the CPU 11 reads the ID stored in the ROM 14 and that stored in the SRAM 13 to compare two IDs (step ST15).

Nevertheless, as stated above, when the HDD 12 is detached from the system, the ID stored in the SRAM 13 is already lost. The CPU 11 judges as a necessary consequence that two IDs do not coincide with each other (step ST16). Accordingly, the CPU 11 does not permit an actuation of the vehicle navigation system (nonpermission of actuation, step ST17).

As mentioned above, according to the first embodiment, detachment of the HDD 12 in which the map data is stored from the vehicle navigation system leads to a loss of the ID stored in the SRAM 13. Therefore, even if the HDD 12 is attached to the vehicle navigation system again, the ID stored in the ROM 14 and that stored in the SRAM 13 cannot coincide with each other. As a result, the vehicle navigation system does not actuate, which prevents the illegally copied map data from being used.

When making an attempt to legally update the map data by a dealer, the map data should be updated so as not to lose the ID stored in the SRAM. While, in the above first embodiment, discussion is had on the prevention of illegal use of the map data, needless to say, the system is also applicable to prevention of the data being illegally copied at the time the data is updated when data other than map data is used, which is stored in a HDD or the like. As is apparent from the above description, the CPU 11 serves as the actuation permitting means, and the wiring 12a, the first terminal 12b, and the second terminal 12c act as the backup electric power breaking means.

What is claimed is:

1. A data illegal use preventing device comprising:
an information storing and reading unit for readably storing data to which a unique identification value is previously assigned, and being detached from the device;
a volatile memory for storing the identification value assigned to the data read from the information storing and reading unit;
a nonvolatile memory for storing the identification value;
a power supply for supplying backup electric power to the volatile memory;
backup electric power breaking means for breaking a supply of the backup electric power from the power supply to the volatile memory at the time the information storing and reading unit is detached from the device; and
actuation permitting means for permitting an actuation of the device when the identification value stored in the volatile memory coincides with that stored in the nonvolatile memory.

2. The data illegal use preventing device according to claim 1, wherein when electric power is initially applied to the device, the actuation permitting means stores the identification value assigned to the data read from the information storing and reading unit in the volatile memory and in the nonvolatile memory.

3. The data illegal use preventing device according to claim 1, wherein the backup electric power breaking means comprises:
a wiring provided on the information storing and reading unit, for connecting the power supply and the volatile memory;
a first terminal connected to the power supply and the wiring; and
a second terminal connected to the volatile memory and the wiring.

4. The data illegal use preventing device according to claim 1, wherein the data illegal use preventing device is a navigation system, the data is map data, and the information storing and reading unit is a hard disk drive in which the map data is stored.
